(19) United States
(12) Patent Application Publication
(10) Pub. No.: US 2022/0243779 A1
(43) Pub. Date: Aug. 4, 2022

(54) METHOD FOR PRODUCING WET-RUNNING FRICTION PAPER, AND WET-RUNNING FRICTION PAPER

(71) Applicant: Schaeffler Technologies AG & Co. KG, Herzogenaurach (DE)

(72) Inventors: Stefan Steinmetz, Grünstadt (DE); Gregor Mattern, Schöneberg (DE)

(73) Assignee: Schaeffler Technologies AG & Co. KG, Herzogenaurach (DE)

(21) Appl. No.: 17/626,521

(22) PCT Filed: Jul. 21, 2020
(86) PCT No.: PCT/DE2020/100637

§ 371 Date: Jan. 12, 2022

(30) Foreign Application Priority Data
Jul. 26, 2019 (DE) 10 2019 120 310.4
Oct. 1, 2019 (DE) 10 2019 126 429.4

(51) Int. Cl. F16D 69/02; D21H 13/50; D21H 13/26; D21H 11/12; D21H 17/14; D21H 17/48; D21H 17/68; D21H 17/00; D21F 11/02

(52) U.S. Cl. CPC F16D 69/026; D21H 13/50; D21H 13/26; D21H 11/12; D21H 17/14; F16D 2200/0034; D21H 17/68; D21H 17/74; D21F 11/02; F16D 2200/0095; F16D 2200/0065; D21H 17/48

(57) ABSTRACT

A method for producing a wet-running friction paper includes providing a fiber portion with a fiber, providing a filler portion with a filler, providing a binder portion with a phenol-resin-based binder, dissolving the binder portion to form a phenolate, and processing the fiber portion, the filler portion and the phenolate in a paper production process to form the wet-running friction paper.

### CROSS-REFERENCE TO RELATED APPLICATIONS

This application is the United States National Phase of PCT Appln. No. PCT/DE2020/100637 filed Jul. 21, 2020, which claims priority to German Application Nos. DE102019120310.4 filed Jul. 26, 2019 and DE102019126429.4 filed Oct. 1, 2019, the entire disclosures of which are incorporated by reference herein.

### TECHNICAL FIELD

The present disclosure relates to a method for producing a wet-running friction paper and to a wet-running paper which contains at least one fiber portion consisting of at least one type of fiber, a portion of at least one filler, and a portion of a phenol-resin-based binder.

### BACKGROUND

From the document GB-A-2 205 592, a wet-running friction paper, such as friction lining material made of a porous fiber base material, an inert filler and phenol resin, is known. The fiber base material is processed in an aqueous slurry, the phenol resin is processed in the form of an emulsion and the filler is processed into a stock solution. The stock solution is applied in the form of a papermaking process into a Fourdrinier wire, rolled and dried. During the drying process, the phenol resin is hardened under the influence of temperature.

### BRIEF SUMMARY

A method for producing a wet-running friction paper includes providing a fiber portion with a fiber, providing a filler portion with a filler, providing a binder portion with a phenol-resin-based binder, dissolving the binder portion to form a phenolate, and processing the fiber portion, the filler portion and the phenolate in a paper production process to form the wet-running friction paper.

### DETAILED DESCRIPTION

The proposed method is used to produce wet-running friction paper or a layered friction material for friction, clutch and/or braking devices, in particular in a motor vehicle. The wet-running friction paper contains a fiber portion of at least one type of fiber, for example aramid fibers, carbon fibers, cotton fibers such as linter fibers and/or the like, a portion of at least one filler, for example Kieselguhr, such as Celite, graphite, coke and/or the like, and a portion of a phenol-resin-based binder, for example phenol resol and/or the like. Further portions such as silicone resin, silanes, flocculants, retention agents, friction particles and/or the like can be provided.

The wet-running friction paper is manufactured in a papermaking process. This means that, for example, a slurry such as pulp or suspension is formed from the fiber portion and the at least one filler. The fibers are in short cut form, for example with a length of a few millimeters. The high-water-content pulp also contains the binder component, in which a phenol resin component is present as phenolate, possibly alongside other resin components, in that the phenol resin is dissolved in a highly alkaline solution, for example in a sodium or potassium hydroxide solution.

The pulp is processed into the wet-running friction paper in a papermaking process known per se. For example, the pulp is placed on a Fourdrinier wire and rolled in a wet press unit and brought to the appropriate thickness. The pulp is then dried with further rolling, if necessary. In this case, in a dry phase, corresponding rollers can be brought to higher temperatures than the rollers in the wet phase in order to evaporate the remaining solvent, for example water.

According to the present disclosure, the phenol resin portion present dissolved in the pulp as phenolate of the phenol resin is precipitated. For this purpose, the pH of the alkaline pulp is lowered by adding acid, for example the pulp is neutralized, as a result of which the phenolate is converted into an insoluble phenol resin and is precipitated. A dilute acid, such as 5% sulfuric acid, for example, can be used as the precipitating agent. The precipitation process may be carried out in the wet phase at room temperature or ambient temperature of the papermaking process.

By means of the precipitation process and the use of retention agents, for example, a uniform distribution of precipitated phenol resin particles can be achieved over the entire area of the pulp lying on the Fourdrinier wire. In this way, after the pressing and rolling process of the paper production process and drying of the finished wet-running friction paper, a lateral distribution of the phenol resin particles can be achieved over its thickness between the two surfaces so that the friction quality of a friction partner made from the wet-running friction paper has essentially consistent friction properties over its service life.

Furthermore, a particle size of precipitated binder particles such as phenol resin particles can be adjusted by means of a predetermined addition rate of the precipitant. In particular, by adding the precipitant at a rate of 0.5 kg/s, for example, it is possible to achieve small particle diameters of the phenol resin, in particular phenol resol, of below two micrometers, which penetrate the fibers or fiber structures of the fiber portion and attach themselves to the fibers in an even distribution.

By adding appropriate flocculants and/or retention agents, a suitable zeta potential can be set so that a high conversion of the flocculation, essentially 100% addition of the phenol resin, can be achieved.

The degree of hardness of the binder, such as phenol resin, and thus its abrasion resistance, elasticity, temperature resistance and/or the like can be adjusted in a dry phase of the papermaking process. In this case, a uniform temperature can be set on the rollers or an increasing or decreasing temperature profile can be set gradually from roller to roller in the drying phase.

An example composition for producing the wet-running friction paper can, for example, contain
a fiber portion of 40 to 60% by weight, in particular a mixture of aramid fibers, linter fibers and carbon fibers,
a binder portion of 30 to 40% by weight, in particular phenol resin, present as phenolate in alkaline solution, and
a filler portion of 20 to 40% by weight, in particular Celite.

Another example composition contains, for example, in percent by weight
26% aramid fiber
6% linter fiber
9% carbon fiber
30% phenol resin such as phenol resol, present as phenolate in a highly alkaline solution with subsequent precipitation, and
29% Celite.

The present disclosure also provides a wet-running friction paper, in particular produced according to the proposed method. The wet-running friction paper has a uniform distribution of resin particles between the two opposite surfaces thereof. The particle size of the binder particles formed from the binder portion is preferably less than 2 micrometers.

After the papermaking process has been completed, the wet-running friction paper is in sheet form or roll form. The production of friction linings from this wet-running friction paper takes place depending on the later use thereof as a radially or axially effective friction lining by punching, cutting out or the like in the form of a ring or ring segment with radial or axial friction surfaces. Subsequent to the papermaking process or in the dry phase, profiling of the surfaces of the friction lining or the wet-running friction paper can be provided on the intended friction surfaces, for example by means of different intensities of pressing. Alternatively or additionally, application-specific required punctures can be provided.

It goes without saying that, within the meaning of the disclosure, a friction lining, brake lining and/or the like produced from the wet-running friction paper is encompassed by the disclosure and can be asserted as part of the patent application.

1.-10. (canceled)

11. A method for producing a wet-running friction paper comprising:
providing a fiber portion comprising a fiber;
providing a filler portion comprising a filler;
providing a binder portion comprising a phenol-resin-based binder;
dissolving the binder portion to form a phenolate; and
processing the fiber portion, the filler portion and the phenolate in a paper production process to form the wet-running friction paper.

12. The method of claim 11, further comprising:
forming a suspension by mixing the fiber portion, the filler portion and the phenolate;
placing the suspension on a Fourdrinier wire;
drying the suspension; and
hardening the suspension.

13. The method of claim 12, wherein:
the step of forming the suspension comprises:
producing a pulp from the fiber portion and the filler portion; and
adding the phenolate to the pulp; and
the method further comprises precipitating the phenolate.

14. The method of claim 13, wherein:
the phenolate is an alkaline phenolate solution; and
the phenolate is precipitated by a precipitant to form resin particles.

15. The method of claim 14 wherein the precipitant is dilute sulfuric acid.

16. The method of claim 14 wherein a particle size of the resin particles is adjusted by:
a predetermined addition rate of the precipitant; and
a type of the precipitant.

17. The method of claim 12 wherein the binder portion is brought to a predetermined degree of hardness in a dry phase of the paper production process.

18. The method of claim 14 further comprising adjusting a hardness degree of the binder portion by a predetermined temperature profile.

19. The method of claim 11, wherein the wet-running friction paper comprises:
30% to 60% by weight of the fiber portion;
20% to 40% by weight of the filler portion; and
20% to 40% by weight of the binder portion.

20. The method of claim 19 wherein:
the fiber portion comprises a mixture of aramid fibers, linter fibers and carbon fibers;
the binder portion comprises phenol resin; and
the filler portion comprises Celite.

21. The wet-running friction paper produced by the method of claim 11 comprising:
a top surface;
a bottom surface; and
resin particles uniformly distributed between the top surface and the bottom surface.

22. The wet-running friction paper of claim 21 wherein each of the resin particles has a particle size less than 1 micrometer.
